(19) United States
(12) Patent Application Publication
(10) Pub. No.: US 2009/0262315 A1
(43) Pub. Date: Oct. 22, 2009

(54) PROJECTOR AND MODULE OF INTEGRATION ROD

(75) Inventors: Yung-Chuan Tseng, Hsin-Chu (TW); Chun-Ping Wang, Hsin-Chu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CORETRONIC CORPORATION, Hsin-Chu (TW)

(21) Appl. No.: 12/236,508

(22) Filed: Sep. 24, 2008

(30) Foreign Application Priority Data
Apr. 18, 2008 (TW) 97114265

(51) Int. Cl. G03B 21/14

(52) U.S. Cl. 353/119

(57) ABSTRACT

A module of integration rod can be assembled on an optical engine base of a projector. The module of integration rod includes a holder, an integration rod, a cover, at least one elastic element, at least one fastening screw, and at least one adjusting screw. The holder has an accommodating space. The integration rod is inserted in the accommodating space. The integration rod and the holder are disposed on the optical engine base. The cover is disposed on the holder to locate the holder between the cover and the optical engine base. The elastic element is disposed between the holder and the optical engine base. The fastening screw passes through the cover from a first side of the cover and is fastened on the optical engine base. The adjusting screw is fastened on the cover from the first side of the cover and is suitable to lean on the holder.

### CROSS-REFERENCE TO RELATED APPLICATION

This application claims the priority benefit of Taiwan application serial no. 97114265, filed on Apr. 18, 2008. The entirety of the above-mentioned patent application is hereby incorporated by reference herein and made a part of this specification.

### BACKGROUND OF THE INVENTION

1. Field of the Invention

The present invention relates to a module of integration rod, in particular, to a module of integration rod of a projector.

2. Description of Related Art

The current projectors, such as common single beam projectors, may project images with a high picture quality and brightness. Due to the price similar to conventional televisions (TVs) and the advantages of small volume and portability, projectors have been gradually used by ordinary people.

Taiwan Patent No. I274225 has disclosed a projector, which includes a light source device, a projection lens, an optical engine base, an integration rod, a holder, and a positioning structure. The light source device is used to generate light beams. The integration rod is located between the light source device and the projection lens. The light beams generated by the light source device are uniformized and changed the light shape thereof by the integration rod, and then enter the projection lens after being refracted and/or reflected by a plurality of optical elements. Then, the projection lens projects the light beams with an image onto a screen outside the projector.

The optical engine base covers the range of light path of the light beams between the light source device and the projection lens. The upper portion of the optical engine base is a metal sheet and the lower portion is a casing. The integration rod is located between the metal sheet and the casing. The positioning structure includes a plurality of elastic strips respectively formed by punching the metal sheet and used for positioning the integration rod in the optical engine base. A plurality of fastening screws passes through the metal sheet and is locked on the casing to restrict the distance between the metal sheet and the casing. The casing has a screw hole. An adjusting screw is screwed through the screw hole from outside of the casing and butts against the surface of the holder to adjust the position of the integration rod.

The integration rod is generally formed by adhering a plurality of reflectors. Therefore, the adhesive for adhering the reflectors is easily aged under the effect of the high temperature inside the projector, such that the lifespan of the integration rod is limited. When the adhesive for adhering the reflectors is aged, the reflectors may probably collapse, and thus the light beams may not fully pass through the integration rod. Thus, parts of the image projected by the projection lens may not be displayed or may be skewed. At this time, the integration rod needs replacement.

However, when an optical engine base is assembled on a housing of a projector, the metal sheet in the upper portion is located between the lower casing and the housing of the projector. The maintenance man may not directly remove the fastening screws that fasten the metal sheet. That is to say, the maintenance man may not remove the fastening screws unless first detaching the optical engine base from the housing of the projector. After removing the fastening screws, the maintenance man may remove the metal sheet, and then replace the integration rod. Therefore, the maintenance man may not directly remove the fastening screws that fasten the metal sheet, which is very inconvenient for maintenance.

### SUMMARY OF THE INVENTION

The present invention provides a module of integration rod and a projector for simplifying maintenance of the integration rod.

In an embodiment, the present invention provides a module of integration rod suitable to be assembled on an optical engine base of a projector, which includes a holder, an integration rod, a cover, at least one elastic element, at least one fastening screw, and at least one adjusting screw. The holder has an accommodating space. The integration rod is inserted in the accommodating space. The integration rod and the holder are disposed on the optical engine base. The cover is disposed on the holder to locate the holder between the cover and the optical engine base. The elastic element is disposed between the holder and the optical engine base. The fastening screw passes through the cover and is fastened on the optical engine base. The adjusting screw is fastened on the cover and is suitable to lean on the holder.

In an embodiment of the present invention, the fastening screw passes through the cover from a first side of the cover, the adjusting screw is fastened on the cover from the first side of the cover, and the elastic element is located between a second side of the cover opposite to the first side and an optical engine base.

In an embodiment of the present invention, the fastening screw has a first head portion and a first shaft portion. The adjusting screw has a second head portion and a second shaft portion. The first and second head portions are exposed out of the first side of the cover.

In an embodiment of the present invention, the elastic element is an elastic strip or a spring.

In an embodiment of the present invention, the elastic element is integrally formed with the holder.

In an embodiment, the present invention further provides a projector, which includes an optical engine base, a light source device, a light valve, a projection lens, and the above module of integration rod. The light source device is disposed on the optical engine base and is suitable to emit an illumination beam. The above module of integration rod is located in the propagation path of the illumination beam and is suitable to uniformize the illumination beam. The light valve is disposed on the optical engine base. The light valve is located in the propagation path of the uniformized illumination beam and is suitable to convert the uniformized illumination beam into an image beam. The projection lens is disposed on the optical engine base. The projection lens is located in the propagation path of the image beam and is suitable to project the image beam.

In an embodiment of the present invention, the projector further includes a lower casing. The optical engine base is disposed within the lower casing and the holder is located between the cover and the lower casing.

In the embodiments of the present invention, the fastening screws pass through the cover and are fastened on the optical engine base, and the adjusting screw is fastened on the cover. Thus, the integration rod may be assembled/detached or the integration rod may be adjusted and positioned from a side of the optical engine base near the cover. Therefore, the maintenance of the integration rod is simplified.

To make the above features and advantages of embodiments of the present invention more apparent, several embodiments are listed below and a detailed description is made below with reference to the accompanying drawings.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of embodiments of the invention, and are incorporated in and constitute a part of this specification. The drawings illustrate embodiments of the invention and, together with the description, serve to explain the principles of embodiments of the invention.

FIG. 1 is a perspective view of an optical engine according to an embodiment of the present invention.

FIG. 2 is a perspective view of a part of the optical engine in FIG. 1 that is assembled on an optical engine base.

FIG. 3 is an exploded view of the part of the optical engine in FIG. 2.

FIG. 4 is a sectional view taken along the line I-I′ of FIG. 2.

FIG. 5 is a sectional view taken along the line II-II′ of FIG. 2.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

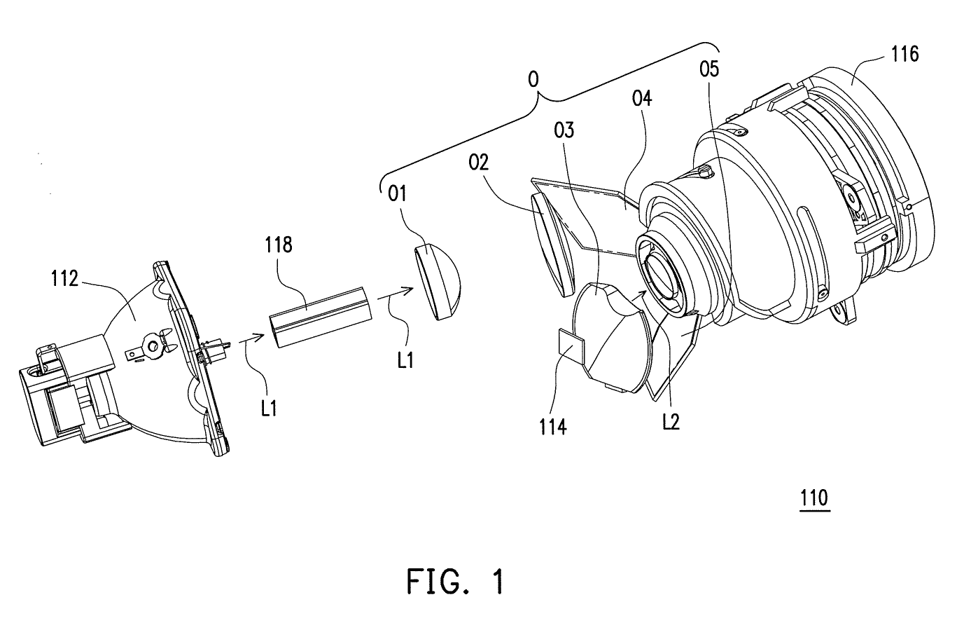

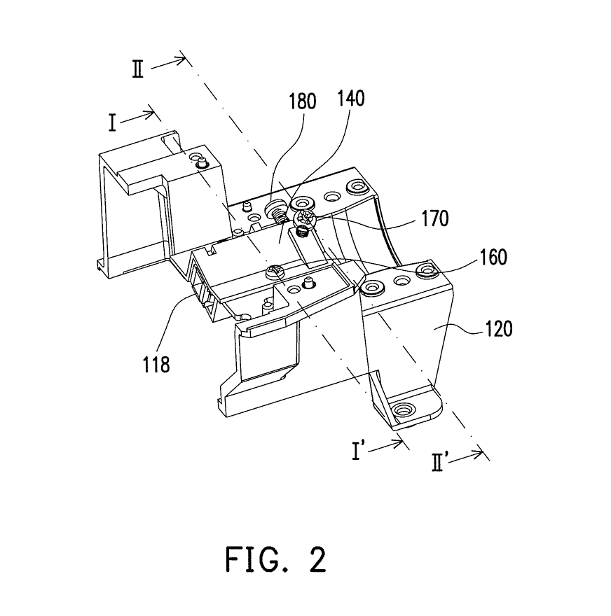

FIG. 1 is a perspective view of an optical engine according to an embodiment of the present invention, and FIG. 2 is a perspective view of a part of the optical engine in FIG. 1 that is assembled on an optical engine base. Referring to FIGS. 1 and 2, the projector of this embodiment includes an optical engine 110 and an optical engine base 120. The optical engine 110 includes a light source device 112, a light valve 114, a projection lens 116, and an integration rod 118. The light source device 112, the light valve 114, the projection lens 116, and the integration rod 118 are disposed on the optical engine base 120. In this embodiment, FIG. 2 schematically shows a part of the optical engine base 120, for illustrating the situation that integration rod 118 is disposed on the optical engine base 120. The other elements 112-116, in addition to the integration rod 118, may be disposed on the optical engine base 120 according to the propagation path of the light beam described below.

With respect to the propagation path of the light beam, the light source device 112 is suitable to emit an illumination beam L1. The integration rod 118 is located in the propagation path of the illumination beam L1 and is suitable to uniformize the illumination beam L1. The light valve 114 is located in the propagation path of the uniformized illumination beam L1. The light valve 114 is suitable to convert the uniformized illumination beam L1 into an image beam L2. The projection lens 116 is located in the propagation path of the image beam L2. When the image beam L2 enters the projection lens 116, the projection lens 116 is suitable to project the image beam L2 onto a screen (not shown).

In addition, in this embodiment, the optical engine 110 may further include a plurality of optical elements O. The optical elements O are located in the propagation path of the illumination beam L1 or the image beam L2. The optical elements O may be a condenser O1, lenses O2 and O3, and reflectors O4 and O5 respectively, for transmitting the illumination beam L1 or the image beam L2 by way of refraction or reflection.

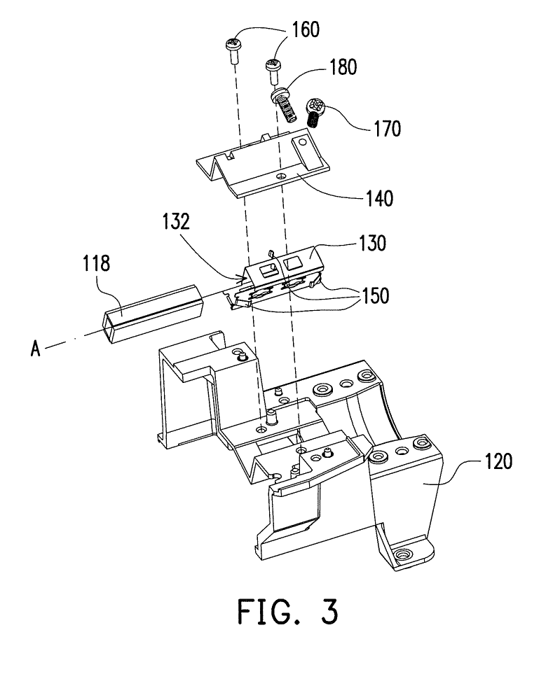

FIG. 3 is an exploded view of the part of the optical engine in FIG. 2. Referring to FIGS. 2 and 3, the above projector further includes a holder 130, a cover 140, at least one elastic element 150 (three of them shown in FIG. 3), at least one fastening screw 160 (two of them shown in FIG. 3), and an adjusting screw 170. From another point of view, the integration rod 118, the holder 130, the cover 140, the elastic elements 150, the fastening screws 160, and the adjusting screw 170 compose a module of integration rod which is detachably assembled on the optical engine base 120.

The holder 130 has an accommodating space 132. The integration rod 118 is inserted in the accommodating space 132. The integration rod 118 and the holder 130 are disposed on the optical engine base 120. The cover 140 is disposed on the holder 130, such that the holder 130 is located between the cover 140 and the optical engine base 120. The elastic elements 150 are disposed between the holder 130 and the optical engine base 120. In this embodiment, the elastic elements 150 are, for example, elastic strips and may be integrally formed with the holder 130. The number, the flexing angle, and the extension direction of the elastic elements 150 may be adjusted based on practical requirements. In addition, in another embodiment (not shown), the elastic elements 150 may alternatively be helical springs.

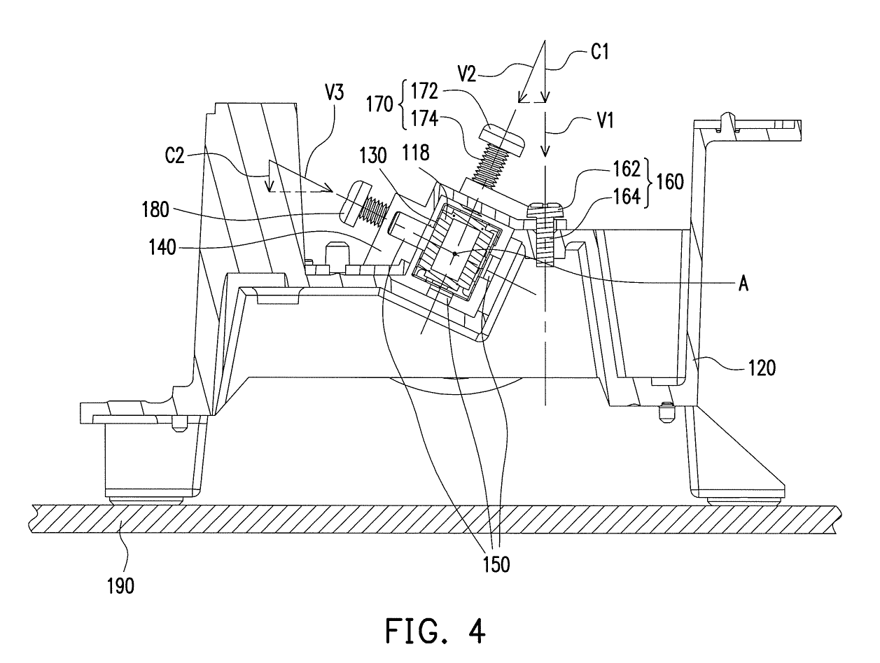

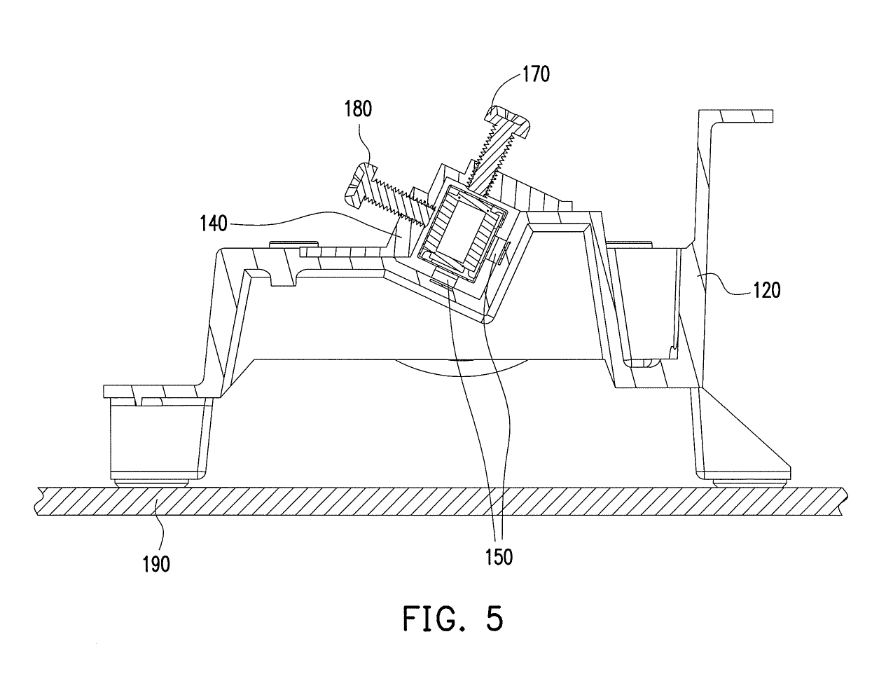

FIG. 4 is a sectional view taken along the line I-I′ of FIG. 2, and FIG. 5 is a sectional view taken along the line II-II′ of FIG. 2. Referring to FIGS. 4 and 5, the fastening screws 160 pass through the cover 140 along a first vector V1 from a first side of the cover 140 (for example, above the cover 140 in FIGS. 4 and 5) and are fastened on the optical engine base 120. The adjusting screw 170 is fastened on the cover 140 along a second vector V2 from the first side of the cover 140 and is suitable to lean on the holder 130. The elastic elements 150 are located between a second side of the cover 140 (for example, below the cover 140 in FIGS. 4 and 5) opposite to the first side and the optical engine base 120. A component C1 of the second vector V2 along the first vector V1 is substantially in the same direction of the first vector V1. When the adjusting screw 170 leans on the holder 130 along the second vector V2, some of the elastic elements 150 generate elastic deformation, such that the integration rod 118 approaches the optical engine base 120 along the second vector V2. Comparatively, when the adjusting screw 170 moves away from the holder 130 along an opposite direction of the second vector V2, a restoring force generated by the elastic elements 150 is exerted on the holder 130 such that the integration rod 118 moves away from the optical engine base 120 along the opposite direction of the second vector V2.

In addition, the above module of integration rod may further include another adjusting screw 180. The adjusting screw 180 is fastened on the cover 140 along a third vector V3 and is suitable to lean on the holder 130. A component C2 of the third vector V3 along the first vector V1 is also substantially in the same direction of the first vector V1. In this embodiment, the projection of the second vector V2 in a plane perpendicular to an extending axis line A of the integration rod is substantially perpendicular to the projection of the third vector V3 in this plane. That is to say, the extending axis line A defines a Z axis and the projections of the second vector V2 and the third vector V3 in the above plane define an X-Y plane, such that the position of the integration rod 118 may be adjusted in the defined X-Y plane to finely adjust the incidence angle of the illumination beam L1 into the integration rod 118. In the above description, the concept of vectors is mainly used to describe the direction of the fastening screws 160 or the adjusting screws 170 and 180 fastened on the optical engine base 120, and the values of the above vectors is not limited.

Further, the above projector may further include a lower casing 190, and FIG. 4 shows the bottom of the lower casing 190. The optical engine base 120 is disposed in the lower casing 190 and a part of the optical engine base 120 is located between the cover 140 and the lower casing 190. The holder 130 is also located between the cover 140 and the lower casing 190. The fastening screws 160 are fastened on the optical engine base 120 towards the bottom of the lower casing 190. In addition, each of the fastening screws 160 may have a first head portion 162 and a first shaft portion 164, and the adjusting screw 170 may have a second head portion 172 and a second shaft portion 174. The first head portion 162 and the second head portion 172 may be exposed out of the cover 140 for screwing in/out the fastening screws 160 and the adjusting screws 170.

In view of the above, in the above embodiments of the present invention, the fastening screws pass through the cover along the first vector and are fastened on the optical engine base. The adjusting screws are fastened on the cover along the second vector. As a component of the second vector along the first vector is substantially in the same direction of the first vector, the integration rod may be assembled/detached or the integration rod may be adjusted and positioned from a same side of the optical engine base. Therefore, the maintenance of the integration rod is simplified.

Besides, in the above embodiments of the present invention, when the optical engine base is assembled on the casing, since the fastening screws are fastened on the optical engine base towards the bottom of the casing, the fastening screws may be detached to remove the cover that is covered on the integration rod and the holder without detaching the optical engine base from the casing. Therefore, the user may replace the integration rod after detaching the cover, which helps to simplifying maintenance of the integration rod.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A module of integration rod suitable to be assembled on an optical engine base of a projector, comprising:
a holder comprising an accommodating space;
an integration rod inserted in the accommodating space, wherein the integration rod and the holder are disposed on the optical engine base;
a cover disposed on the holder to locate the holder between the cover and the optical engine base;
at least one fastening screw passing through the cover from a first side of the cover and being fastened on the optical engine base;
at least one adjusting screw being fastened on the cover from the first side of the cover and suitable to lean on the holder; and
at least one elastic element located between a second side of the cover opposite to the first side and the optical engine base.

2. The module of integration rod according to claim 1, wherein the fastening screw comprises a first head portion and a first shaft portion, the adjusting screw comprises a second head portion and a second shaft portion, and the first head portion and the second head portion are exposed out of the first side of the cover.

3. The module of integration rod according to claim 1, wherein the elastic element is an elastic strip or a spring.

4. The module of integration rod according to claim 1, wherein the elastic element is integrally formed with the holder.

5. A projector, comprising:
an optical engine base;
a light source device disposed on the optical engine base and suitable to emit an illumination beam;
a module of integration rod located in a propagation path of the illumination beam, wherein the module of integration rod is suitable to uniformize the illumination beam, comprising:
a holder comprising an accommodating space;
an integration rod inserted in the accommodating space and located in the propagation path of the illumination beam, wherein the integration rod and the holder are disposed on the optical engine base;
a cover disposed on the holder to locate the holder between the cover and the optical engine base;
at least one fastening screw passing through the cover from a first side of the cover and being fastened on the optical engine base;
at least one adjusting screw fastened on the cover from the first side of the cover and suitable to lean on the holder; and
at least one elastic element located between a second side of the cover opposite to the first side and the optical engine base;
a light valve disposed on the optical engine base and located in the propagation path of the uniformized illumination beam, wherein the light valve is suitable to convert the uniformized illumination beam into an image beam; and
a projection lens disposed on the optical engine base and located in the propagation path of the image beam and suitable to project the image beam.

6. The projector according to claim 5, further comprising:
a lower casing, wherein the optical engine base is disposed on the lower casing, and the holder is located between the cover and the lower casing.

7. The projector according to claim 5, wherein the fastening screw comprises a first head portion and a first shaft portion, the adjusting screw comprises a second head portion and a second shaft portion, and the first head portion and the second head portion are exposed out of the first side of the cover.

8. The projector according to claim 5, wherein the elastic element is an elastic strip or a spring.

9. The projector according to claim 5, wherein the elastic element is integrally formed with the holder.
